(19) United States
(12) Patent Application Publication
(10) Pub. No.: US 2019/0188533 A1
(43) Pub. Date: Jun. 20, 2019

(54) POSE ESTIMATION

(71) Applicant: MASSACHUSETTS INSTITUTE OF TECHNOLOGY, Cambridge, MA (US)

(72) Inventors: Dina Katabi, Boston, MA (US); Antonio Torralba, Cambridge, MA (US); Hang Zhao, Cambridge, MA (US); Mingmin Zhao, Cambridge, MA (US); Tianhong ` Li, Cambridge, MA (US); Mohammad Abualsheikh, Cambridge, MA (US); Yonglong Tian, Cambridge, MA (US)

(21) Appl. No.: 16/225,837

(22) Filed: Dec. 19, 2018

Related U.S. Application Data
(60) Provisional application No. 62/650,388, filed on Mar. 30, 2018.
(60) Provisional application No. 62/607,687, filed on Dec. 19, 2017.

(51) Int. Cl. G06K 9/62; G06K 9/00; G01B 15/00

(52) U.S. Cl. CPC G06K 9/6256; G01B 15/00; G06K 9/00369; G06K 9/00348

(57) ABSTRACT

A method for pose recognition includes storing parameters for configuration of an automated pose recognition system for detection of a pose of a subject represented in a radio frequency input signal. The parameters having been determined by a first process including accepting training data including a number of images including poses of subjects and a corresponding number of radio frequency signals and executing a parameter training procedure to determine the parameters. The parameter training procedure including, receiving features characterizing the poses in each of the images, and determining the parameters that configure the automated pose recognition system to match the features characterizing the poses from the corresponding radio frequency signals.

### CROSS-REFERENCE TO RELATED APPLICATIONS

This application claims the benefit of U.S. Provisional Application No. 62/607,687 filed Dec. 19, 2017 and of U.S. Provisional Application No. 62/650,388 filed Mar. 30, 2018, both of which are incorporated herein.

### BACKGROUND

This invention relates to pose recognition.

The past decade has witnessed much progress in using RF signals to localize people and track their motion. Some localization algorithms have led to accurate localization to within tens of centimeters. Advanced sensing technologies have enabled tracking people based on the RF signals that bounce off their bodies, even when they do not carry any wireless transmitter.

In a related field, estimating the human pose is an important task in computer vision with applications in surveillance, activity recognition, gaming, etc. The pose estimation problem is defined as generating two-dimensional (i.e., 2-D) or three-dimensional (i.e., 3-D) skeletal representations of the joints on the arms and legs, and keypoints on the torso and head. It has recently witnessed major advances and significant performance improvements. However, as in any camera-based recognition task, occlusion remains a fundamental challenge. Some conventional approaches mitigate occlusion by estimating the occluded body parts based on the visible ones. Yet, since the human body is deformable, such estimations are prone to errors. Further, this approach becomes infeasible when the person is fully occluded, behind a wall or in a different room.

### SUMMARY

Very generally, some aspects described herein relate to accurate human pose estimation through walls and occlusions. Aspects leverage the fact that, while visible light is easily blocked by walls and opaque objects, radio frequency (RF) signals in the WiFi range can traverse such occlusions. Further, they reflect off the human body, providing an opportunity to track people through walls.

Some aspects use a deep neural network approach that parses radio signals to estimate two-dimensional (i.e., 2-D) poses and/or three-dimensional (i.e., 3-D) poses.

In the 2-D case, a state-of-the-art vision model is used to provide cross-modal supervision. For example, during training the system uses synchronized wireless and visual inputs, extracts pose information from the visual stream, and uses it to guide the training process. Once trained, the network uses only the wireless signal for pose estimation.

The design and training of the neural network addresses a number of challenges that are not addressed by pose estimation techniques. One challenge is that there is no labeled data for this task and it is infeasible for humans to annotate radio signals with keypoints. To address this problem, a cross-modal supervision is used. During training, a camera is located with an RF antenna array, and the RF and visual streams are synchronized. Pose information is estimated from the visual stream is used as a supervisory signal for the RF stream. Once the system is trained, it only uses the radio signal as input. The result is a system that is capable of estimating human pose using wireless signals only, without requiring human annotation as supervision. Interestingly, the RF-based model learns to perform pose estimation even when the people are fully occluded or in a different room. It does so despite never having seen such examples during training. The design of the neural network also accounts for certain intrinsic features of RF signals including low spatial resolution, specularity of the human body at RF frequencies that traverse walls, and differences in representation and perspective between RF signals and the supervisory visual stream.

In the 3-D case, RF signals in the environment are used to extract full three-dimensional (i.e., 3-D) poses/skeletons of multiple subjects (including the head, arms, shoulders, hip, legs, etc.), even in the presence of walls and occlusions. In some aspects, the system generates dynamic skeletons that follow the subjects as they move, walk or sit. Certain aspects are based on a convolutional neural network (CNN) architecture that performs high-dimensional (e.g., four dimensional) convolutions by decomposing them into lower-dimensional operations. This property allows the network to efficiently condense the spatiotemporal information in the RF signals. In some examples, the network first zooms in on the individuals in the scene and isolates (e.g., crops) the RF signals from each subject. For each individual subject, the network localizes and tracks their body parts (e.g., head, shoulders, arms, wrists, hip, knees, and feet).

3-D skeletons/poses have applications in gaming where they can extend systems like Microsoft's Kinect to function in the presence of occlusions. They may be used by law enforcement personnel to assess a hostage scenario, leveraging the ability of RF signals to traverse walls. They also have applications in healthcare, where they can track motion disorders such as involuntary movements (i.e., dyskinesia) in Parkinson's patients.

Aspects may have one or more of the following advantages.

Among other advantages, in some aspects the neural network system is able to parse wireless signals to extract accurate 2-D and 3-D human poses, even when the people are occluded or behind a wall.

Aspects are portable and passive in that they generalize to new scenes. Furthermore, aspects do not require subjects to wear any electronics or markers, as opposed to motion capture systems that require every person in the scene to put reflective markers around every keypoint.

Aspects generate accurate 3-D skeletons and localize every keypoint on each person with respect to a global reference frame. Aspects are robust to various types of occlusions including self-occlusion, inter-person occlusion and occlusion by furniture or walls. Such data is necessary to enable RF-Pose to estimate 3-D skeletons from different perspectives despite occlusions.

Aspects are able to track the 3-D skeletons of multiple people simultaneously so that RF-Pose has training examples with multiple people and hence can scale to such scenarios.

Other features and advantages of the invention are apparent from the following description, and from the claims.

### DESCRIPTION OF DRAWINGS

FIG. 1 is a runtime configuration of a 2-D pose estimation system.

FIG. 2 is a representation of a vertical heatmap and a horizontal heatmap relative to an image.

FIG. 3 is a student neural network.

FIG. 4 is a training configuration of the 2-D pose estimation system of FIG. 1.

FIG. 5 is a runtime configuration of a 3-D pose estimation system.

FIG. 6 is a single-person 3-D pose estimation network.

FIG. 7 is a multi-person 3-D pose estimation network.

FIG. 8 is a training configuration of the 3-D pose estimation system of FIG. 5.

FIG. 9 is a multi-view geometry module configuration.

### DESCRIPTION

The embodiments described herein generally relate to the use of deep neural networks to estimate poses of subjects such as humans from radio frequency signals that have impinged upon and reflected from the subjects. Embodiments are able to distinguish the poses of multiple subjects in both two and three dimensions and in the presence of occlusions.

### 1 2-D Pose Estimation

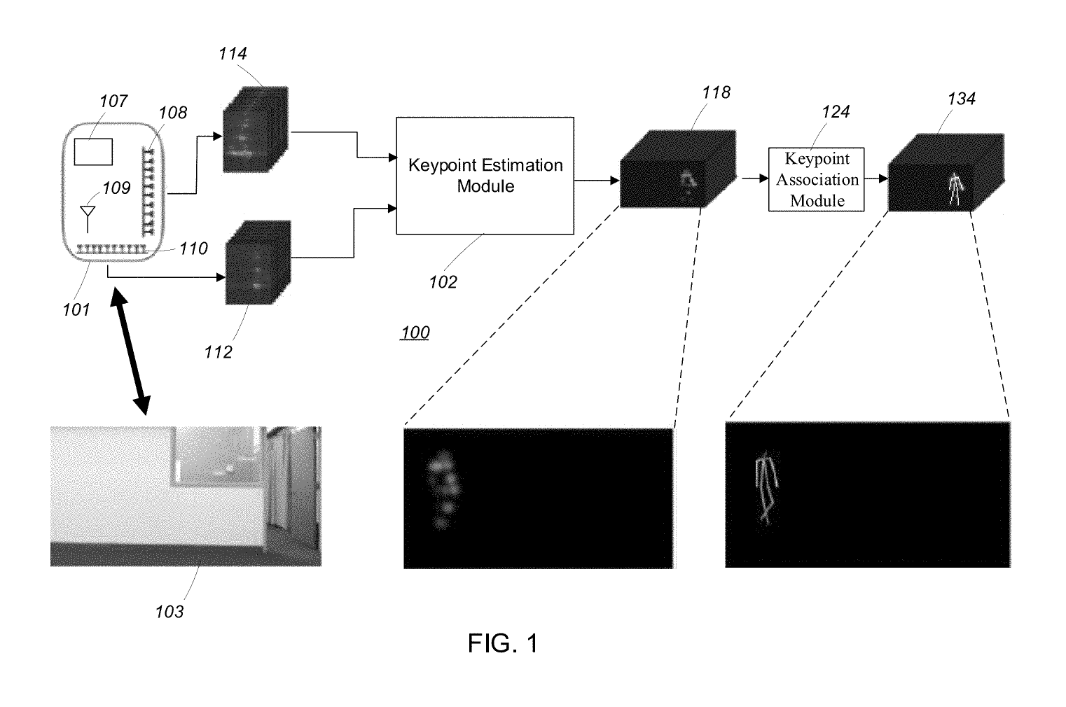

Referring to FIG. 1, a 2-D pose estimation system 100 is configured to sense an environment 103 a using radio frequency (RF) localization technique and to estimate a pose of one or more subjects (who may be partially or fully occluded) in the environment 103 based on that sensing. The 2-D pose estimation system 100 includes a sensor subsystem 101, a keypoint estimation module 102, and a keypoint association module 124.

Very generally, the sensor subsystem 101 interacts with the environment 103 to determine sequences of two-dimensional RF heatmaps 112, 114. The sequences of two-dimensional RF heatmaps 112, 114 are processed by the keypoint estimation module to generate a sequence of estimated keypoint confidence maps 118 indicating an estimated location of keypoints (e.g., legs, arms, hands, feet, etc.) of a subject (e.g., a human body) in the environment 103.

The sequence of estimated keypoint confidence maps 118 is processed by the keypoint association module 124 to generate a sequence of depictions of posed skeletons 134 in the environment 103.

### 1.1 Sensor Subsystem

In some examples, the sensor subsystem 101 includes a radio 107 connected to a transmit antenna 109 and two receive antenna arrays: a vertical antenna array 108 and a horizontal antenna array 110.

The radio is configured to transmit a low power RF signal into the environment 103 using the transmit antenna 109. Reflections of the transmitted signal are received at the radio 107 through the receive antenna arrays 108, 110. To separate RF reflections from different objects in the environment 103, the sensor subsystem 101 is configured to use the antenna arrays 108, 110 to implement an extension of the FMCW (Frequency Modulated Continuous Wave) technique. In general, FMCW separates RF reflections based on the distance of the reflecting object. The antenna arrays 108, 110, on the other hand separate reflections based on their spatial direction. The extension of the FMCW technique transmits FMCW signals into the environment 103 and processes the reflections received at the two receive antenna arrays 108, 100 to generate two sequences of two-dimensional heatmaps, a horizontal sequence of two-dimensional heat maps 112 for the horizontal antenna array 110 and a vertical sequence of two-dimensional heat maps 114 for the vertical antenna array 108.

Certain aspects of the sensor subsystem 101 are described in greater detail and/or are related to techniques and embodiments described in one or more of:
U.S. Pat. No. 9,753,131,
U.S. Patent Publication No. 2017/0074980,
U.S. Patent Publication No. 2017/0042432,
F. Adib, C.-Y. Hsu, H. Mao, D. Katabi, and F. Durand. Capturing the human figure through a wall. ACM Transactions on Graphics, 34(6):219, November 2105. 1,3,
F. Adib, Z. Kabelac, D. Katabi, and R. C. Miller. 3D tracking via body radio reflections. In Proceedings of the USENIX Conference on Networked Systems Design and Implementation, NSDI, 2014, 1,3, and
C.-Y. Hsu, Y. Liu, Z. Kabelac, R. Hristov, D. Katabi, and C. Liu. Extracting gait velocity and stride length from surround radio signals. In Proceedings of the 2017 CHI Conference on Human Factors in Computing Systems, CHI 20176. 1.
   all of which are incorporated herein by reference.

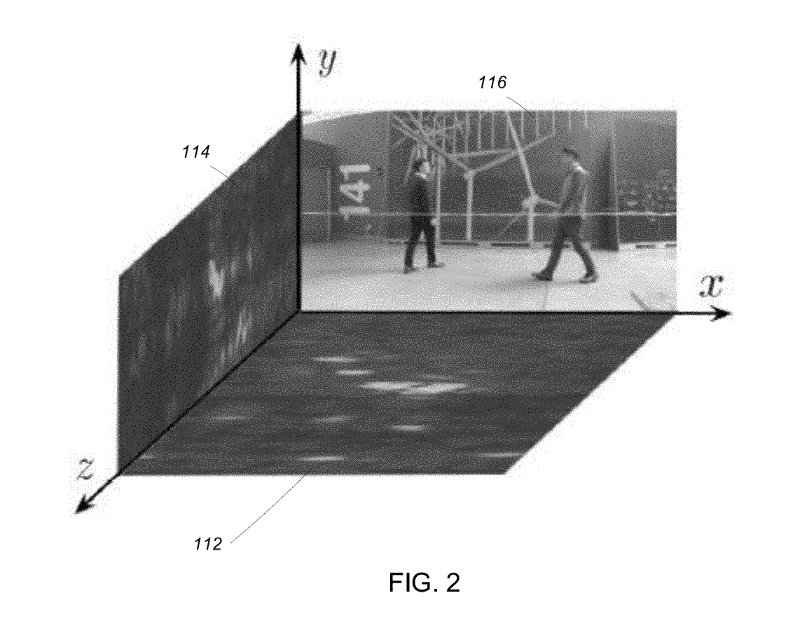

Referring to FIG. 2, the horizontal heatmap 112 associated with the horizontal antenna array 110 is a projection of the signal reflections on a plane parallel to the ground. Similarly, the vertical heatmap 114 is a projection of the reflected signals on a plane perpendicular to the ground. Note that since RF signals are complex numbers, each pixel in the heatmaps is associated with a real component and an imaginary component. In some examples, the sensor subsystem 101 generates 30 pairs of heatmaps per second.

### 1.2 Keypoint Estimation Module

Referring again to FIG. 1, the sequences of heatmaps 112, 114 are provided to the keypoint estimation module 102 as input. The keypoint estimation module 102 processes the sequences of heatmaps 112, 114 in a deep neural network to generate the sequence of keypoint confidence maps 118.

### 1.2.1 Data Considerations

As is described in greater detail below, the deep neural network implemented in the keypoint estimation module 102 uses a cross-modal student-teacher training methodology (where the keypoint estimation module 102 is the ‘student’ network) that transfers visual knowledge of a subject's pose using synchronized images of the subject (collected from a camera) and RF heatmaps of the same subject as a bridge.

The structure of the keypoint estimation module 102 is at least in part a consequence the student-teacher training methodology employed. In particular, RF signals have intrinsically different properties than visual data, i.e., camera pixels.

For example, RF signals in the frequencies that traverse walls have low spatial resolution, much lower than visual data. The resolution is typically tens of centimeters and is defined by the bandwidth of the FMCW signal and the aperture of the antenna array. The radio attached to the antenna arrays 108, 110 may have a depth resolution of about 10 cm, and the antenna arrays 108, 100 may have vertical and horizontal angular resolution of 15 degrees.

Furthermore, the human body is specular in the frequency range that traverse walls. The human body reflects the signal that falls on it. Depending on the orientation of the surface of each limb, the signal may be reflected towards the sensor or away from it. Thus, in contrast to camera systems where any snapshot shows all unoccluded keypoints, in radio systems, a single snapshot has information about a subset of the limbs and misses limbs and body parts whose orientation at that time deflects the signal away from the sensor.

Finally, the wireless data has a different representation (complex numbers) and different perspectives (horizontal and vertical projections) from a camera.

### 1.2.2 Keypoint Prediction Module Structure

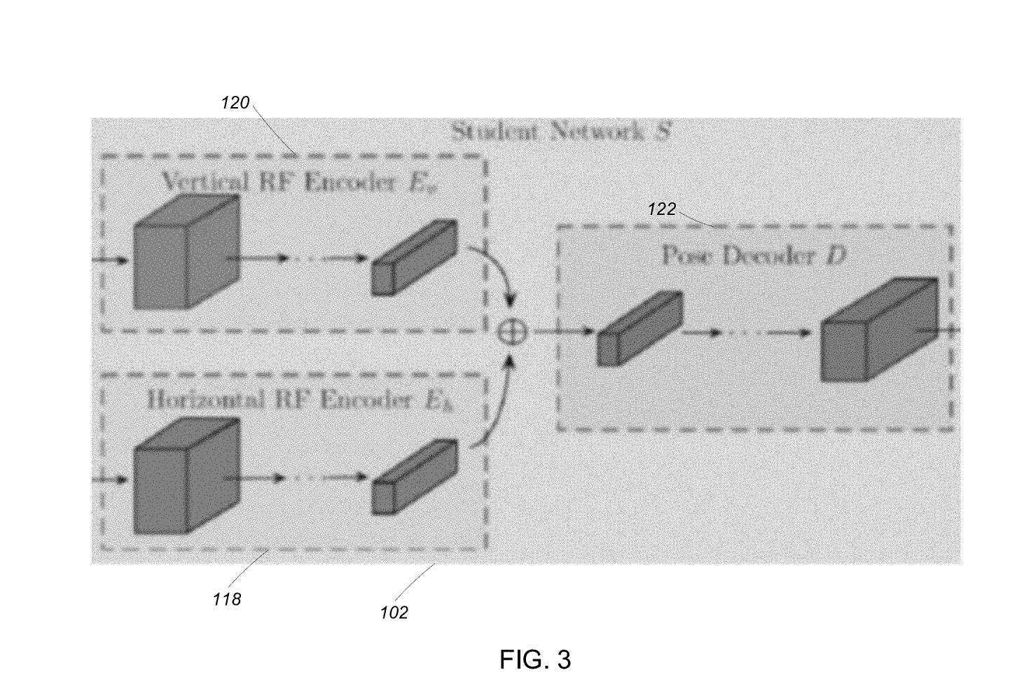

Referring to FIG. 3, the design of the keypoint estimation module 102 has to account for the above-described properties of RF signals. That is, the human body is specular in the RF range of interest. Hence, the human pose cannot be estimated from a single RF frame (a single pair of horizontal and vertical heatmaps) because the frame may be missing certain limbs even though they are not occluded. Furthermore, RF signals have low spatial resolution, so it will be difficult to pinpoint the location of a key point using a single RF frame.

The keypoint estimation module 102 therefore aggregates information from multiple frames of RF heatmaps so that it can capture different limbs and model the dynamics of body movement. Thus, instead of taking a single frame as input (i.e., a single pair of vertical and horizontal heatmaps), the keypoint estimation module 102 takes sequences of frames as input. For each sequence of frames, the keypoint estimation module 102 outputs the same number of keypoint confidence maps 118 as the number of frames in the input (i.e., while the network looks at a clip of multiple RF frames at a time, it still outputs a pose estimate for every frame in the input).

The keypoint estimation module 102 also needs to be invariant to translations in both space and time so that it can generalize from visible scenes to through-wall scenarios. Spatiotemporal convolutions are therefore used as basic building blocks for the keypoint estimation module 102.

Finally, the keypoint estimation module 102 is configured to transform the information from the views of the RF heatmaps 112, 114 to the view of the camera (described in greater detail below) in the teacher network. To do so, the keypoint estimation module 102 is configured to decode the RF heatmaps 112, 114 into the view of the camera. To do so, the keypoint estimation module 102 includes two RF encoding networks, Eₕ(⋅) 118 for encoding a sequence of horizontal heatmaps 112 and Eᵥ(⋅) 120 for encoding a sequence of vertical heatmaps 114.

In some examples, the RF encoding networks 118, 120 use strided convolutional networks to remove spatial dimensions in order to summarize information from the original views. For example, the RF encoding networks may take 100 frames (3.3 seconds) of RF heatmap data as input. The RF encoding network uses 10 layers of 9×5×5 spatiotemporal convolutions with 1×2×2 strides on spatial dimensions every other layer.

The keypoint estimation module 102 also includes a pose decoding network, D(⋅) 122 that takes a channel-wise concatenation of horizontal and vertical RF encodings as input and processes the inputs to generate estimated keypoint confidence maps 118. In some examples, the pose decoding network 122 then uses fractionally strided convolutional networks to decode keypoints in the camera's view. For example, the pose decoding network 122 may use spatiotemporal convolutions with fractionally strided convolutions to decode the pose. In some examples, the pose decoding network has 4 layers of 3×6×6 with fractionally stride of 1×½×½, except the last layer has one of 1×¼×¼.

### 1.3 Keypoint Association Module

In some examples, the sequence of estimated keypoint confidence maps 118 generated by the keypoint estimation module 102 is provided to a keypoint association module 124 which maps the keypoints in the estimated confidence maps 118 to depictions of posed skeletons 134.

In some examples, the keypoint association module 124 performs a non-maximum suppression on the keypoint confidence maps 118 to obtain discrete peaks of keypoint candidates. In the case that the keypoint candidates belong to multiple subjects in the scene, keypoints of different subjects are associated, the relaxation method proposed by Cao et al. and Euclidean distance is used for the weight of two candidates. Note that association is performed on a frame-by-frame basis based on the learned keypoint confidence maps 118.

### 1.4 Keypoint Prediction Module Training

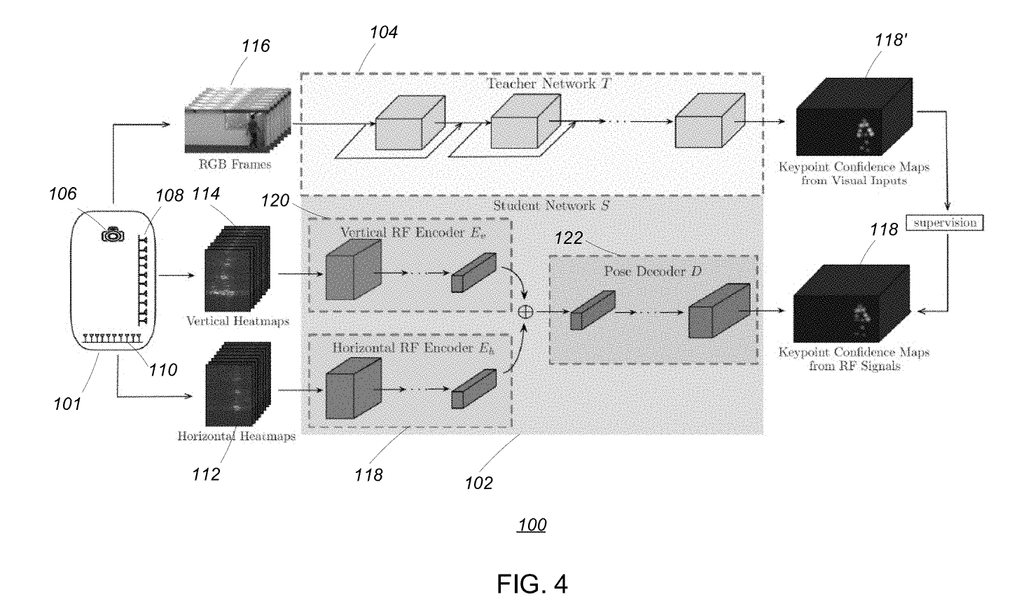

Referring to FIG. 4, the 2-D pose estimation system 100 of FIG. 1 is configured for training the keypoint estimation module 102. In the training configuration, the sensor subsystem 101 additionally includes a camera 106 (mentioned above) for collecting image data in the environment 103. In some examples, the camera 106 is a conventional, off-the-shelf web camera that generates RGB video frames 116 at a framerate of 30 frames per second. The 2-D pose estimation system 100 also includes a ‘teacher’ network 104 when in the training configuration.

### 1.4.1 Teacher-Student Training Paradigm

In the teacher-student training paradigm, the teacher network 102 provides cross-modal supervision and the keypoint estimation module 104 performs RF-based pose estimation.

While training, the teacher network 104 receives the sequence of RGB frames 116 generated by the camera 106 of the sensor subsystem 101 and processes the sequence of RGB frames 116 using a vision model (e.g., Microsoft COCO) to generate a sequence of keypoint confidence maps 118′ corresponding to the sequence of RGB frames 116. For each pixel of a given RGB frame 116 in the sequence of RGB frames 116, the corresponding keypoint confidence map 118 indicates the confidence that the pixel is associated with a particular keypoint (e.g., the confidence that the pixel is associated with a hand or a head). In general, the keypoint confidence maps 118′ generated by the teacher network 104 are treated as ground truth.

As was the case in the ‘runtime’ example described above, the sensor subsystem 101 also generates two sequences of two-dimensional heatmaps, a horizontal sequence of two-dimensional heat maps 112 for the horizontal antenna array 110 and a vertical sequence of two-dimensional heat maps 114 for the vertical antenna array 108.

The sequence of keypoint confidence maps 118 and the sequences of vertical and horizontal heatmaps 112,114 are provided as input to the keypoint estimation module 102 as supervised training input data. The keypoint estimation module 112 processes the inputs to learn how to estimate the keypoint confidence maps 118 from the heatmap data 112, 114.

For example, consider a synchronized pair (I, R), where R denotes the combination of the vertical and horizontal heatmaps 112,114, and I denotes the corresponding image data. The teacher network, T(⋅) 104 takes the sequence of RGB frames 116 as input and estimates keypoint confidence maps, T(I) 118 for those RGB frames 116. The estimated confidence maps T(I) provide cross-modal supervision for the keypoint estimation module S(⋅), which learns to estimate keypoint confidence maps 118 from the heatmap data 112, 114. The keypoint estimation module 102 learns to estimate keypoint confidence maps 118 corresponding to the following anatomical parts of the human body: head, neck, shoulders, elbows, wrists, hips, knees and ankles. The training objective of the keypoint estimation module S(⋅) is to minimize the difference between its estimation S(R) and the teacher network's estimation T(I):

$${min}_{S} {\sum }_{( I , R )} L ( T ( I ) , S ( R ) )$$

The loss is defined as the summation of binary cross entropy loss for each pixel in the confidence maps:

$$L ( T , S ) = - {\sum }_{c} {\sum }_{i , j} {S}_{ij}^{c} log {T}_{ij}^{c} + ( 1 - {S}_{ij}^{c} ) log ( 1 - {T}_{c}^{ij} ) ,$$

where Tᵢⱼ^{c} and Sᵢⱼ^{c} are the confidence scores for the (i, j)-th pixel on the confidence map c.

As is noted above, the training process results in a keypoint estimation module 102 that accounts for the properties of RF signals such as specularity of the human body, low spatial resolution. and invariance to translations in both space and time. The keypoint estimation module 102 also learns a representation of the information in the heatmaps that is not encoded in original spatial space, and is therefore able to decode that representation into keypoints in the view of the camera 106 using the two RF encoding networks, Eₕ(⋅) 118 and Eᵥ(⋅) 120.

### 2 3-D Pose Estimation

The design described above can be extended to 3-D pose estimation. Very generally, a 3-D pose estimation system is structured around three components that together provide an architecture for using deep learning for RF-sensing. Each component serves a particular function.

A first component relates to sensing the 3-D skeleton. This component takes the RF signals that bounce off someone's body and leverages deep convolutional neural network (CNN) to infer the person's 3-D skeleton. There is a key challenge, however, in adapting CNNs to RF data. The RF signal is a 4-dimensional function of space and time. Thus, the CNN needs to apply 4-D convolutions. But common deep learning platforms do not support 4-D CNNs. They are targeted to images or videos, and hence support only up to 3-D convolutions. More fundamentally, the computational and I/O resources required by 4-D CNNs are excessive and limit scaling to complex tasks like 3-D skeleton estimation. To address this challenge, certain aspects leverage the properties of RF signals to decompose 4-D convolutions into a combination of 3-D convolutions performed on two planes and the time axis. Some aspects also decompose CNN training and inference to operate on those two planes. This approach not only addresses the dimensional difference between RF data and existing deep learning tools, but also reduces the complexity of the model and speed up training by orders of magnitude.

A second component relates to scaling to multiple people. Most environments have multiple people. To estimate the 3-D skeletons of all individuals in the scene, a component that separates the signals from each individual so that it may be processed independently to infer his or her skeleton is needed. The most straightforward approach to this task would run past localization algorithms, locate each person in the scene, and zoom in on signals from that location. The drawbacks of such approach are: 1) localization errors will lead to errors in skeleton estimation, and 2) multipath effects can create fictitious people. To avoid these problems, this component is designed as a deep neural network that directly learns to detect people and zoom in on them. However, instead of zooming in on people in the physical space, the network first transforms the RF signal into an abstract domain that condenses the relevant information, then separates the information pertaining to different individuals in the abstract domain. This allows the network to avoid being fooled by fictitious people that appear due to multipath, or random reflections from objects in the environment.

A third component is related to training. Once the network is set up, it needs training data—i.e., it needs many labeled examples where each example is a short clip (3-second) of received RF signals and a 3-D video of the skeletons and their key points as functions of time. Past work in computer vision is leveraged in which, given an image of people, identifies the pixels that correspond to their keypoints. To transform such 2-D skeletons to 3-D skeletons, a coordinated system of cameras is developed. 2-D skeletons from each camera are collected and an optimization problem is designed based on multi-view geometry to find the 3-D location of each keypoint of each person. Of course, the cameras are used only during training to generate labeled examples. Once the network is trained, the radio can be placed in a new environment and use the RF signal alone to track the 3-D skeletons and their movements.

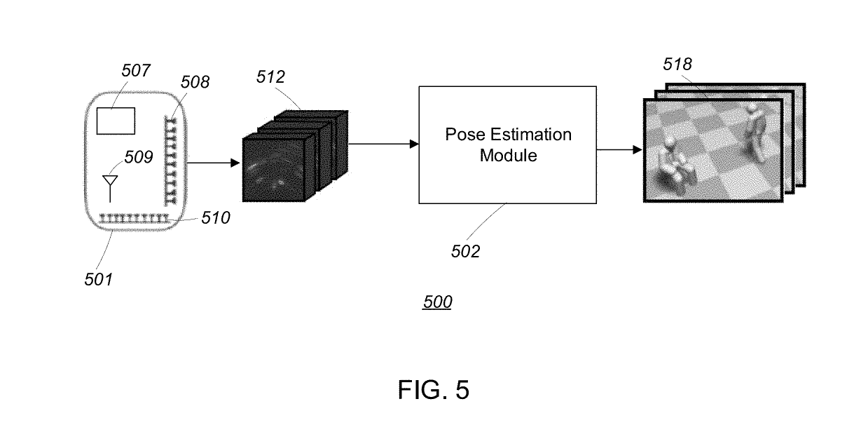

Referring to FIG. 5, a 3-D pose estimation system 500 is configured to sense an environment using a radio frequency (RF) localization technique and to estimate a three-dimensional pose of one or more subjects (who may be partially or fully occluded) in the environment based on the sensing. The 3-D pose estimation system 500 includes a sensor subsystem 501 and a pose estimation module 502.

Very generally, the sensor subsystem 501 interacts with the environment to determine four-dimensional (4-D) functions of space and time, referred to as ‘4-D RF tensors’ 512. The 4-D RF tensors 512 are processed by the pose estimation module 502 to generate a sequence of three-dimensional (3-D) poses 518 of one or more subjects in the environment.

### 2.1 Sensor Subsystem

In some examples, the sensor subsystem 501 includes a radio 507 connected to a transmit antenna 509 and two receive antenna arrays: a vertical antenna array 108 and a horizontal antenna array 110. This antenna configuration allows the radio 507 to measure the signal from different 3-D voxels in space. For example, the RF signals reflected from a location (x, y, z) in space can be computed as:

$$a ( x , y , z , t ) = {\sum }_{k} {\sum }_{i} {s}_{k , i}^{t} \cdot exp ( j 2 π \frac{{d}_{k} ( x , y , z )}{{λ}_{i}} )$$

where s_{k,i}^{t} is the i-th sample of an FMCW sweep received on the k-th receive antenna at the time index t (i.e., the FMCW index), λᵢ is the wavelength of the signal at the i-th sample in the FMCW sweep, and dₖ (x, y, z) is the round-trip distance from the transmit antenna to the voxel (x,y,z), and back to the k-th receive antenna.

The 4-D RF tensors 512 generated by the sensor subsystem 510 represent the measured signal for a set of 3-D voxels in space as they progress in time.

### 2.2 Pose Estimation Module

The 4-D RF tensors 512 are provided to the pose estimation module 502 which processes the 4-D RF tensors 512 to generate the sequence of 3-D poses 518. In some examples, the pose estimation module 502 implements a neural network model that is trained (as described in greater detail below) to extract a sequence of 3-D poses 518 of one or more subjects in the environment from the 4-D RF tensors 512.

### 2.2.1 Single Subject Pose Estimation

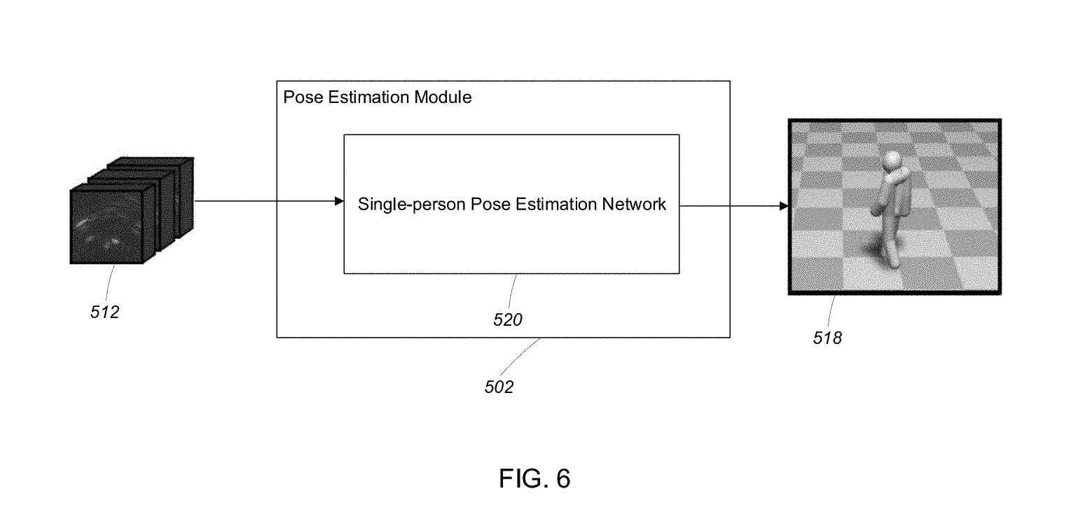

Referring to FIG. 6, in one example, the pose estimation module 502 is configured to extract 3-D poses 518 of a single subject in the environment from the 4-D RF tensors 512 using a single-person pose estimation network 520. In some examples, the single-person pose estimation network 520 is a convolutional neural network (CNN) model configured to identify the 3-D locations of 14 anatomical keypoints on a subject's body (head, neck, shoulders, elbows, wrists, hips, knees and ankles) from 4-D RF tensor data 512.

Keypoint localization can be formulated as a CNN classification problem and a CNN architecture can therefore be designed to solve the keypoint classification problem. To do so, the space of interest (i.e., the environment) is discretized into 3-D voxels. In some examples, the set of classes includes all 3-D voxels in the space of interest, and the goal of the CNN Is to classify the location of each keypoint (head, neck, elbow, etc.) into one of the 3-D voxels. Thus, to localize a keypoint, the CNN outputs scores s={s_{ν}}_{ν∈V} corresponding to all 3-D voxels ν∈V, and the target voxel ν* is the one that contains the keypoint. SoftMax loss L_{Softmax}(s,ν*) is used as the looks for keypoint localization.

To localize all 14 keypoints, instead of having a separate CNN for each of the keypoints, a single CNN the outputs scores s^{k} for each of the 14 keypoints is used. This design forces the model to localize all of the keypoints jointly and infers the localization of occluded keypoints based on the locations of other keypoints. The total loss of pose estimation is the sum of the SoftMax loss of all 14 keypoints:

$${L}_{pose} = {\sum }_{k} {L}_{Softmax} ( {s}^{k} , {υ}^{{k}^{*}} ) ,$$

where the index k refers to a particular keypoint. Once the model is trained, it can estimate the location of each keypoint k as the voxel with the highest score:

$${\hat{υ}}_{k} = arg {max}_{υ} {s}_{υ}^{k}$$

In some examples, to localize keypoints in 3-D space, the CNN model aggregates information over space to analyze all of the RF reflections from a subject's body and assign scores for each voxel. Also, the model aggregates information across time to infer keypoints that may be occluded at a specific time instance. Thus, the model takes the 4-D RF tensors 512 (space and time) as input and performs a 4-D convolution at each layer to aggregation information along space and time:

aⁿ=fⁿ*_{(4D)}aⁿ⁻¹

where aⁿ and aⁿ⁻¹ are the feature maps at layer n and n−1, fⁿ is the 4-D convolution filter at layer n and *_{(4D)} is the 4-D convolution operator.

The 4-D CNN model described above has practical issues. The time and space complexity of 4-D CNN is so prohibitive that major machine learning platforms (PyTorch, Tensorflow) only support convolution operation up to 3-D. To appreciate the computational complexity of such model, consider performing 4-D convolutions on the 4-D RF tensor. The size of the convolution kernel is fixed and relatively small. So, the complexity stems from convolving with all 3 spatial dimensions and the time dimension. For example, to span an area of 100 square meters with 3 meters of elevation the area needs to be divided into voxels of 1 cm³ to have a good resolution of the location of a keypoint. Also say that a time window of 3 seconds is used and that there are 30 RF measurements per voxel per second. Performing a 4-D convolution on such tensor involves 1,000×1,000×300×90, i.e., 27 giga opera-ions. When training, this process has to be repeated for each example in the training set, which can contain contains over 1.2 million such examples. The training can take multiple weeks. Furthermore, the inference process cannot be performed in real time. Details of a decomposition that allows reduced the complexity of the 4-D CNN such that model training time is vastly reduced and inference can be performed in real time can be found in provisional patent application No. 62/650,388, which has been incorporated herein by reference.

### 2.2.2 Multiple Subject Pose Estimation

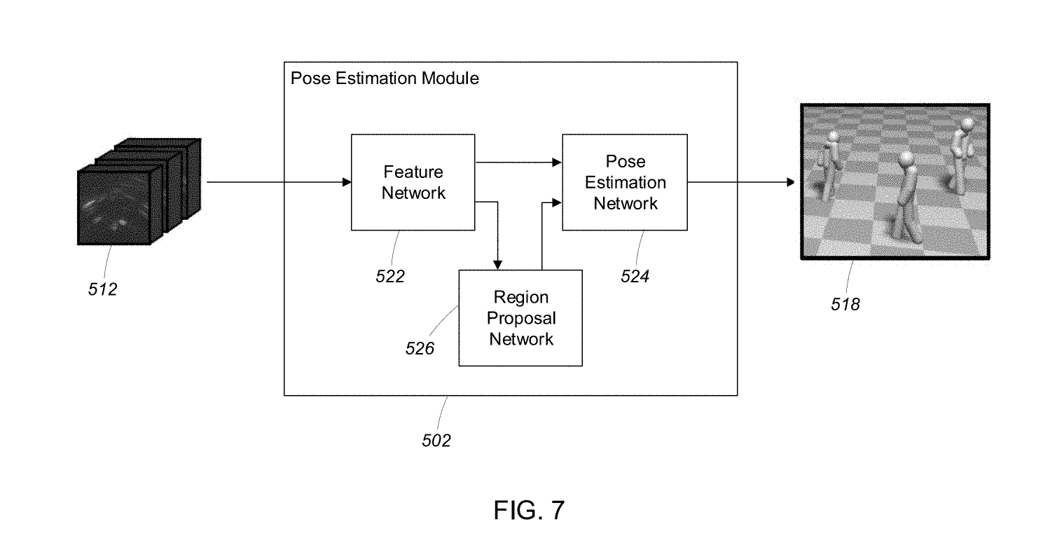

Referring to FIG. 7, in another example, the pose estimation module 502 is configured to extract 3-D poses 518 of multiple subjects in the environment from the 4-D RF tensors 512. Very generally, the pose estimation module 502 follows a divide-and-conquer paradigm by first detecting subject (e.g., people) regions and then zooming into each region to extract a 3-D skeleton for each subject. To do so, the pose estimation module 502 of FIG. 7 includes a region proposal network 524 and splits the single-person pose estimation network 520 of FIG. 6 into a feature network 522 and a pose estimation network 524. The feature network 522 is an intermediate layer of the single-person posed estimation network 520 of FIG. 6 and is configured to process the 4-D RF tensor data 512 to generate feature maps. In some examples, the single person network contains 18 convolutional layers. The first 12 layers are split into feature network 522 and the remaining 6 layers into pose estimation network 520. Where to split is not unique, but generally the feature network 522 should have enough layers to aggregate spatial and temporal information for the subsequent region proposal network 526 and pose estimation network 524.

The feature maps are provided to the pose estimation network 524 and to the region proposal network 526. In some examples, the region proposal network 526 receives feature maps output by the feature network 522 as input and outputs a set of rectangular region proposals, each with a score describing the probability of the region containing a subject. In general, the region proposal network 526 is implemented as a standard CNN.

In some examples, use of the output of feature network 522 allows the pose estimation module 502 to detect objects at the intermediate layer of after information has been condensed rather than attempting to directly detect objects in the 4-D RF tensors 512. Use of condensed information from the feature network 522 addresses the problem that the raw RF signal is cluttered and suffers from multipath effect. Using a number of convolutions layers to condense the information before providing the information to the region proposal network 524 for cropping a specific region removes the clutter from the raw RF signal. Furthermore, when multiple subjects are present, they may occlude each other from the sensor subsystem 501, resulting in missing reflections from the occluded subject. Thus, performing a number of 4-D spatiotemporal convolutions to combine information across space and time allows the region proposal network 524 to detect a temporarily occluded subject.

The potential subject regions detected by the region proposal network 524 in the feature maps are zoomed in on and cropped. In some examples, the cropped regions are cuboids which tightly bound subjects. In other examples, the 3-D cuboid detection is simplified as a 2-D bounding box detection on the horizontal plane (recall that the 4-D convolutions are decomposed to two 3-D convolutions over horizontal and vertical planes and the time axis).

The feature maps generated by the feature network 522 and the cropped regions of the feature maps generated by the region proposal network 526 are provided to the pose estimation network 524.

The pose estimation network 524 is trained (as is described in greater detail below) to estimate 3-D poses 518 from the feature maps and the cropped regions of the feature maps in much in much the same way as the single-person pose estimation network 520 of FIG. 6.

### 2.3 Pose Estimation Module Training

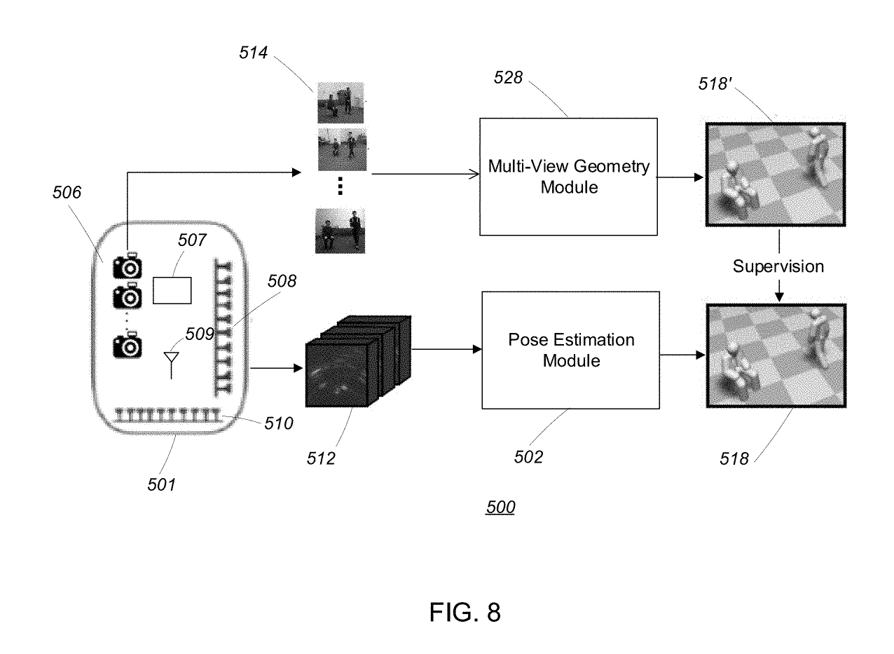

Referring to FIG. 8, the 3-D pose estimation system 500 of FIG. 5 is configured for training the pose estimation module 502. In the training configuration, the sensor subsystem 510 additionally includes a number of cameras 506 for collecting image data 514 in the environment. The camera nodes are synchronized via NTP and calibrated with respect to one global coordinate system using standard multi-camera calibration techniques. Once deployed, the cameras image subjects from different viewpoints. The 3-D pose estimation system 500 also includes a multi-view geometry module 528 that serves as a ‘teacher’ network when in the training configuration.

### 2.3.1 Teacher-Student Training Paradigm

In the teacher-student training paradigm, the multi-view geometry module 528 (i.e., the teacher network) provides cross-modal supervision and the pose estimation module 502 performs RF-based pose estimation.

While training, the multi-view geometry module 528 receives sequences of RGB images 514 from the cameras 506 of the sensor subsystem 101 and processes the sequences of RGB frames 514 (as is described in greater detail below) to generate 3-D poses 518′ corresponding the sequences of RGB frames 514.

As was described in the ‘runtime’ example described above, the sensor subsystem 104 generates 4-D RF tensors 512. The 4-D RF tensors 512 and the 3-D poses 518′ generated by the multi-view geometry module 528 are provide to the pose estimation module 502 as supervised training input data. The pose estimation module 502 processes the inputs to learn how to estimate the 3-D poses 518 from the RF tensor data 512. As is described above, the design of the CNN used to estimate 3-D poses outputs scores for each of 14 keypoints and forces the motel to localize all of the keypoints jointly. The pose estimation CNN learns to infer the localization of occluded keypoints based on the locations of other keypoints.

It is noted that one way to train the region proposal network 526 of the pose estimation module 502 is to try to all possible regions in a feature map, and for each region classify it as correct if it fits tightly around a real subject in the scene. In other examples, potential regions are sampled using a sliding window. For each sampled window, a classifier is used to determine whether it intersects reasonably well with a real subject. If it does, region proposal network 526 adjusts the boundaries of that window to make it fit better.

A binary label is assigned to each window for training to indicate whether it contains a subject or not. To set the label, a simple intersection-over-union (IoU) metric is used, which is defined as:

$$IoU = \frac{Area of Intersection}{Area of Union}$$

Therefore, a window that overlaps more than 0.7 IoU with any ground truth region (i.e., a region corresponding to a real person) is set as positive and a window that overlaps less than 0.3 IoU with all ground truth is set as negative. Other windows which satisfy neither of the above criteria are ignored during the training stage.

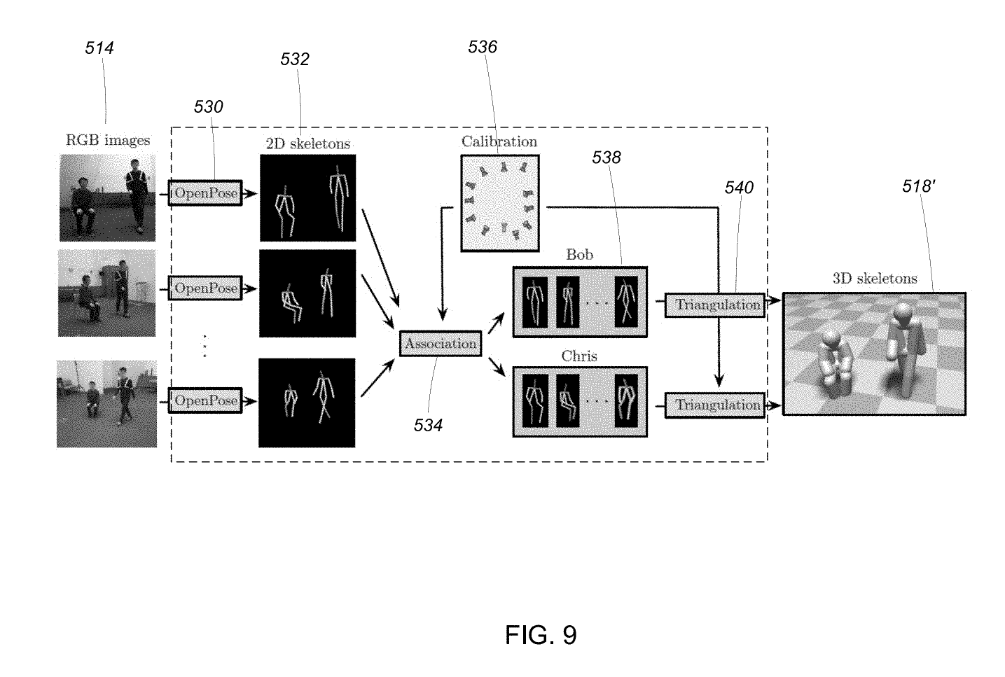

Referring to FIG. 9, the multi-view geometry module 528 generates the 3-D poses 318′ for supervised training by first receiving the sequences of RGB images 514 taken from different viewpoints by the cameras 106 of the sensor subsystem 101. The images 514 are provided to a computer vision system 530 such as OpenPose to generate 2-D skeletons of 532 of the subjects in the images. In some examples, images 514 taken by different cameras 106 may include different people or different keypoints of the same person.

Geometric relationships between 2-D skeletons are determined and used to identify which 2-D skeletons belong to which subjects in the sequences of images 514. For example, given a 2-D keypoint (e.g., a head), the original 3-D keypoints must lie on a line in the 3-D space that is perpendicular to the camera view and intersects it at the 2-D keypoint. The intuition is that when a pair of 2-D skeletons are both from the same person, those two lines corresponding to the potential location of a particular keypoint will intersect in 3-D space. On the other hand, if the pair of 2-D skeletons are from two different people, those two lines in 3-D space will have a large distance and no intersection. Based on this intuition, the average distance between the 3-D lines corresponding to various keypoints is used as the distance metric of two 2-D skeletons, and hierarchical clustering is used to cluster 2-D skeletons from the same person.

Once multiple 2-D skeletons from the same person 538 are identified, their keypoints are triangulated 540 to generate the corresponding 3-D skeleton, which is included in the 3-D pose 518′. In some examples, the 3-D location of a particular keypoint, p is estimated using its 2-D projections pⁱ as the point in space whose projection minimizes the sum of distances from all such 2-D projections, i.e.:

$$p = arg {min}_{p} {\sum }_{i ∈ I} ‖ {C}_{i} p - {p}^{i} {‖}_{{2}^{′}}^{2}$$

where the sum is over all cameras that detected that keypoint, and Cᵢ is the calibration matrix that transforms the global coordinates to the image coordinates in the view of camera i.

### 3 Implementations

Systems that implement the techniques described above can be implemented in software, in firmware, in digital electronic circuitry, or in computer hardware, or in combinations of them. The system can include a computer program product tangibly embodied in a machine-readable storage device for execution by a programmable processor, and method steps can be performed by a programmable processor executing a program of instructions to perform functions by operating on input data and generating output. The system can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

It is to be understood that the foregoing description is intended to illustrate and not to limit the scope of the invention, which is defined by the scope of the appended claims. Other embodiments are within the scope of the following claims.

What is claimed is:

1. A method for pose recognition comprising storing parameters for configuration of an automated pose recognition system for detection of a pose of a subject represented in a radio frequency input signal, the parameters having been determined by a first process comprising:
accepting training data comprising a plurality of images including poses of subjects and a corresponding plurality of radio frequency signals; and
executing a parameter training procedure to determine the parameters, the parameter training procedure including,
receiving features characterizing the poses in each of the images, and
determining the parameters that configure the automated pose recognition system to match the features characterizing the poses from the corresponding plurality of radio frequency signals.

2. The method of claim 1 wherein the features characterizing the poses include features characterizing points in space.

3. The method of claim 2 wherein the features characterizing the poses in space include features characterizing points in three-dimensional space.

4. The method of claim 1 further comprising performing the first process to determine the parameters.

5. The method of claim 1 further comprising processing the plurality of images to identify the features characterizing the poses in each of the images.

6. A method for detection of a pose of a subject represented in a radio frequency input signal using an automated pose recognition system configured according to predetermined parameters, the method comprising:
processing successive parts of the radio frequency input signal using the automated pose recognition system to identify features characterizing poses of the subject in the sections of the radio frequency input signal.

7. The method of claim 6 wherein the predetermined parameters were determined by a first process comprising:
accepting training data comprising a plurality of images including poses of subjects and a corresponding plurality of radio frequency signals, and
executing a parameter training procedure to determine the parameters, the parameter training procedure including,
receiving features characterizing the poses in each of the images, and
determining the parameters that configure the automated pose recognition system to match the features characterizing the poses from the corresponding plurality of radio frequency signals.

8. The method of claim 6 wherein the features characterizing the poses include features characterizing points in space.

9. The method of claim 8 wherein the features characterizing the poses in space include features characterizing points in three-dimensional space.

10. The method of claim 6 further comprising using the features characterizing the poses to identify keypoints on the subject.

11. The method of claim 10 further comprising using the keypoints to determine the poses of the subject.

12. The method of claim 10 further comprising connecting the identified keypoints on the subject to generate a skeleton representation of the subject.

13. A system for detection of a pose of a subject represented in a radio frequency signal, the system configured according to predetermined parameters and comprising:
a radio frequency signal processor for processing successive parts of the radio frequency input signal according to the predetermined parameters to identify features characterizing poses of the subject in the sections of the radio frequency input signal.

14. The system of claim 13 wherein the predetermined parameters were determined by a first process comprising:
accepting training data comprising a plurality of images including poses of subjects and a corresponding plurality of radio frequency signals, and
executing a parameter training procedure to determine the parameters, the parameter training procedure including,
receiving features characterizing the poses in each of the images, and
determining the parameters that configure the automated pose recognition system to match the features characterizing the poses from the corresponding plurality of radio frequency signals.

15. The system of claim 13 wherein the features characterizing the poses include features characterizing points in space.

16. The system of claim 15 wherein the features characterizing the poses in space include features characterizing points in three-dimensional space.

17. Software stored on non-transitory machine-readable media having instructions stored thereupon, wherein instructions are executable by one or more processors to:
accept training data comprising a plurality of images including poses of subjects and a corresponding plurality of radio frequency signals; and
execute a parameter training procedure to determine the parameters, the parameter training procedure including,
receiving features characterizing the poses in each of the images, and
determining parameters that configure an automated pose recognition system to match the features characterizing the poses from the corresponding plurality of radio frequency signals.

18. The software of claim 17 wherein the instructions are further executable by the one or more processors to process the plurality of images to identify the features characterizing the poses in each of the images.

19. The software of claim 19 wherein the features characterizing the poses include features characterizing points in space.

20. The software of claim 19 wherein the features characterizing the poses in space include features characterizing points in three-dimensional space.
